(19) United States
(12) Patent Application Publication
(10) Pub. No.: US 2010/0110460 A1
(43) Pub. Date: May 6, 2010

(54) IMAGE FORMING SYSTEM AND IMAGE FORMING APPARATUS

(75) Inventor: Yuji MIYATA, Kitanagoya-shi (JP)

Correspondence Address: Scully, Scott, Murphy &Presser, P.C., 400 Garden City Plaze, Suite 300, Garden City, NY, 11530, US

(73) Assignee: BROTHER KOGYO KABUSHIKI KAISHA, Aichi-ken (JP)

(21) Appl. No.: 12/609,793

(22) Filed: Oct. 30, 2009

(30) Foreign Application Priority Data
Oct. 30, 2008 (JP) 2008-279319

(51) Int. Cl. H04N 1/60; G06F 15/00

(52) U.S. Cl. 358/1.9; 358/1.15

(57) ABSTRACT

An image forming apparatus includes: an image forming unit; a communication unit configured to receive image data and an instruction; a nonvolatile memory configured to store color correction data; a color correction data generating unit configured to generate a new color correction data and update the color correction data stored in the nonvolatile memory with the new color correction data; and a control unit. When the instruction contains a first instruction which instructs performing the printing operation without updating the color correction data, the control unit corrects a gradation of an image contained in the image data using existing color correction data stored in the nonvolatile memory. When the instruction does not contain the first instruction and also when a given condition is satisfied, the control unit causes the color correction data generating unit to generate the new color correction data and update the color correction data with the new color correction data, and corrects the gradation of the image contained in the image data using the new color correction data. When the instruction does not contain the first instruction and also when the given condition is not satisfied, the control unit corrects the gradation of the image contained in the image data using the existing color correction data stored in the nonvolatile memory.

### CROSS-REFERENCE TO RELATED APPLICATIONS

This application claims priority from Japanese Patent Application No. 2008-279319 filed on Oct. 30, 2008, the entire contents of which are incorporated herein by reference.

### TECHNICAL FIELD

The present invention relates to an image forming system and an image forming apparatus capable of prohibiting generation of color correction data while printing a series of continuous image information.

### BACKGROUND

In an image forming apparatus such as a color laser printer, the image forming characteristics generally change because of the use environment of the printer and the elapsed period of time, etc. For example, in an electrophotographic laser printer, even if the same image information is printed, the image quality of output image becomes different due to consumption of toner, characteristics of the photosensitive drum, and aging changes.

The printer may perform operations so as to correct the image forming characteristics described above, which is generally called as a calibration. In the calibration, a printer prints density patches on a photosensitive drum configured to an electrostatic latent image and/or the transfer belt. Next, a sensor the printer reads the printed results of the density patches. Accordingly, the printer obtains actually measured density data. The actually measured density data are color correction data. Then, a γ table is created so as to reflect the obtained color correction data in the image information in printing as correction values. The image information is corrected based on the y table.

Actually, in order to look into fluctuations in the image forming characteristics, the density patches are printed on the photosensitive drum forming electrostatic latent images and/or the transfer belt in the color laser printer, the printed results are read by a sensor, and color correction data are thereby created. Since such operations are carried out for various densities for each color of yellow, magenta, cyan and black, it takes a significant amount of time for the work to create color correction data in a series of calibrations, and further no printing is made available during the calibration process.

In addition, when considering a case in which creation of color correction data is instructed during a printing of image information containing a plurality of pages in accordance with the use environment of the printer and the elapsed period of time, the gradations of formed images are different from each other with respect to the image corrected based on the color correction data before the instruction to create color correction data and the image corrected based on the color correction data after the instruction to create color correction data.

A known technique of a printing system is proposed in view of the above circumstances. In the technique, a printing job transmitted from a computer to a printer includes control data showing whether the calibration is executed, and no calibration is carried out in accordance with the control data during a printing process of the printing job. Consequently, the calibration process may be prohibited during printing of one printing job. Therefore, on printing the print job, no calibration process is executed during the printing, time required for the calibration process is no longer necessary, and the gradation of images does not change when printing the printing job.

### SUMMARY

The user of the printer may desire continuously print images with the same gradation, for example, without changing the gradation of image information for a front side of the recording sheet and image information for a back-side of the recording sheet such as in the front-side image information and the back-side image information in a manual duplex printing. Further, when printing a plurality of pieces of image information created by application software of a personal computer, the user may desire to continuously print the plurality of pieces of image information with the same image gradation.

However, in the above-described related-art technique, when the manual duplex printing is performed, i.e., when the front-side image information and back-side image information are printed, if an instruction to create color correction data is given after a printing process of the front-side image information but before start of a printing process of the back-side image information, a creation process of color correction data is executed before the start of the back-side printing. As a result, gradations in an image between the front-side image info nation and the back-side image information differ from each other. Similarly, in a case in which a plurality of pieces of image information created by application software of the personal computer are to be printed, if an instruction to create color correction data is given after a printing process of one piece of image information but before a printing process of a next piece of image information, a creation process of color correction data is executed.

The present invention was made in consideration of the above-described circumstances, and an object thereof is to provide an image forming apparatus and an image forming system capable of selecting a case in which a user prints a series of continuous pieces of image information desired to be printed with the same gradation and capable of prohibiting generation or updating of color correction data during the printing of the selected series of continuous pieces of image information. An image forming system comprising:

According to an aspect of the invention, there is provided an information processing apparatus comprising a first communication unit; and an image forming apparatus comprising: a second communication unit configured to receive image information transmitted from the first communication unit; and an image forming unit configured to form an image on a recording sheet based on the image information; wherein at least one of the information processing apparatus and the image forming apparatus comprises an instructing unit configured to give a correction instruction to instruct a generation of color correction data used for a correction of the image information, wherein the information processing apparatus comprises: a selection unit configured to select whether to print a plurality of pieces of image information as a series of continuous pieces of image information without performing the correction of the color correction data during a printing of the series of continuous pieces of image information; and a prohibition transmission unit configured to transmit the image information and a prohibition instruction for prohibiting generation of color correction data if the selection unit selects that the image information is to be printed as the series of continuous pieces of image information, and wherein the image forming apparatus comprises: a color correction data generating unit configured to generate color correction data based on the correction instruction from the instructing unit; a receiving unit configured to receive the image information and the prohibition instruction which are transmitted from the prohibition transmission unit through the first communication unit and the second communication unit; and a prohibition control unit configured to prohibit the generation of color correction data until the image forming unit finishes the printing of the series of continuous pieces of image information when the receiving unit receives the series of continuous pieces of image information and the prohibition instruction, even if the instructing unit gives the instruction to generate the color correction data.

According to another aspect of the invention, there is provided an image forming apparatus comprising: an image forming unit configured to perform a printing operation so as to print an image on a recording medium; a communication unit configured to receive image data and an instruction for controlling the image forming apparatus; a nonvolatile memory configured to store color correction data; a color correction data generating unit configured to generate a new color correction data and update the color correction data stored in the nonvolatile memory with the new color correction data; and a control unit connected to the image forming unit, the communication unit, the color correction data generating unit and the nonvolatile memory, wherein when the control unit receives the image data and the instruction via the communication unit, the control unit is operable to: perform a first correction when the instruction contains a first instruction which instructs performing the printing operation without updating the color correction data, wherein, in the first correction, the control unit corrects a gradation of an image contained in the image data using existing color correction data stored in the nonvolatile memory; perform a second correction when the instruction does not contain the first instruction and also when a given condition is satisfied, wherein, in the second correction, the control unit causes the color correction data generating unit to generate the new color correction data and update the color correction data stored in the nonvolatile memory with the new color correction data, and corrects the gradation of the image contained in the image data using the new color correction data; perform a third correction when the instruction does not contain the first instruction and also when the given condition is not satisfied, wherein, in the third correction, the control unit corrects the gradation of the image contained in the image data using the existing color correction data stored in the nonvolatile memory; and control the image forming unit so as to form an image on the recording medium based on corrected image data that have been corrected by one of the first correction, the second correction and the third correction.

### BRIEF DESCRIPTION OF DRAWINGS

FIG. 1 is a diagram showing one example of printing system including a network printer and a client terminal apparatus for instructing printing of image information to the network printer, according to an embodiment of the invention;

FIG. 2 is a block diagram showing the network printer;

FIG. 3 is a block diagram showing the client terminal apparatus;

FIG. 4 is an appearance view showing one example of the network printer;

FIG. 5 is a flowchart regarding instructions to generate color correction data;

FIG. 6 is a flowchart regarding a color correction data generation and a printing process of the network printer;

FIG. 7 is a flowchart of a printing execution process of the network printer;

FIG. 8 is a flowchart regarding initial setting of a printing process of the client terminal apparatus;

FIG. 9 is a view of a user interface showing a printing setting screen;

FIG. 10 is a flowchart of a manual duplex printing process;

FIG. 11 is a view of a user interface instructing setting of sheets for printing back-side;

FIG. 12 is a flowchart of a color-valance-fixed continuous printing process; and

FIG. 13 is a view of a user interface showing an end confirmation screen of the color-valance-fixed continuous printing.

### DESCRIPTION

Hereinafter, an image forming system according to an embodiment of the invention, which includes an information processing apparatus and an image forming apparatus, according to embodiments of the present invention will be described with reference to the accompanying drawings.

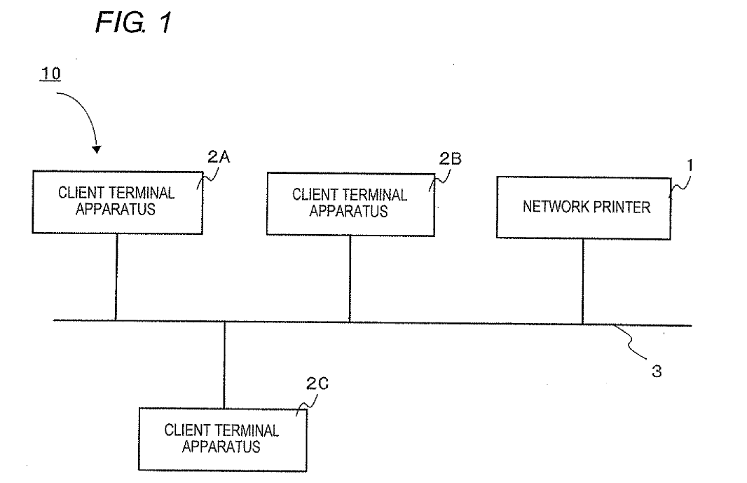

FIG. 1 shows an exemplified image forming system 10 including a network printer 1 (one example of the image forming apparatus) and client terminal apparatuses 2A to 2C (one example of the information processing apparatus) for instructing printing of image information to the network printer 1. In the image forming system 10, three client terminal apparatuses 2A through 2C are connected the network printer 1 via a LAN (Local Area Network) 3 so as to communicate with one another. In the following description, the client terminal apparatuses 2A to 2C may be merely referred to as a “client terminal apparatus 2” unless otherwise specified.

The number of client terminal apparatuses 2 connected to the network printer 1 is not limited to three, and any number (one or more) of client terminal apparatuses 2 may be connected. Further, a plurality of network printers 1 may be connected to the LAN 3.

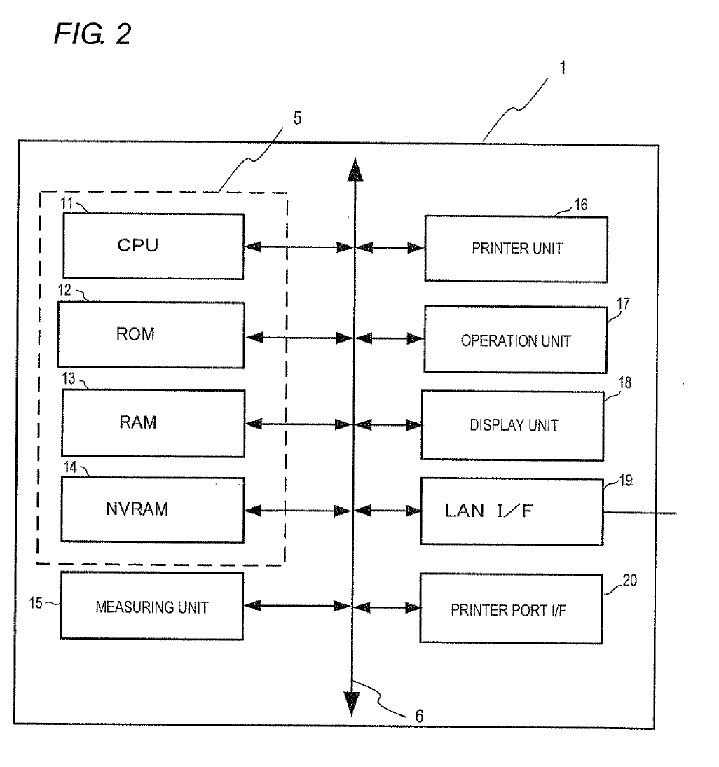

Hereinafter, a configuration of the network printer 1 is described with reference to FIG. 2. As shown in FIG. 2, the network printer 1 can execute a reception printing process in which the network printer 1 receives image information from the client terminal apparatus 2 and prints the received image information. Here, the reception printing process is a series of processes including a receiving process for receiving image information and a printing process for printing the received image information.

The network printer 1 receives image data described by a Page Description Language (PDL) page by page from the client terminal apparatus 2 as one example of the image information, and executes the printing process thereof.

A control unit 5 of the network printer 1 controls the entire operation of the network printer 1. As shown in FIG. 2, the control unit 5 is configured as a microcomputer, which includes a Central Processing Unit (CPU) 11, a Read Only Memory (ROM) 12, a Random Access Memory (RAM) 13, and a Non-Volatile RAM (NVRAM) 14. The control unit 5 is connected to a measuring unit 15, a printer unit 16, an operation unit 17, a display unit 18, a Local Area Network Interface (LAN I/F) 19 and a Printer Port Interface (printer port I/F) 20 via a bus 6 so as to communicate therewith. The configuration of the network printer 1 is not limited thereto, and various modifications may be made without departing from the spirit and scope of the present invention.

The CPU 11 controls elements or units constituting the network printer 1 in accordance with a program stored in the ROM 12, etc. The RAM 13 functions as the main memory and work area of the CPU 11, and has various types of set information stored therein. Image data transmitted from the client terminal apparatus 2 are temporarily stored in the RAM 13. The image data stored in the RAM 13 is subjected to a printing process in the printer unit 16.

The NVRAM 14 stores various types of set data regarding the network printer 1, which are to be held even after the power is turned off. Color correction data used for a correction of image forming characteristics of the network printer 1 are stored in the NVRAM 14.

The control unit 5 including the CPU 11, ROM 12, RAM 13 and NVRAM 14 is operable as an instructing unit, a color correction data generating unit, a receiving unit, a prohibition control unit, a permission unit and a suspending unit in an image forming apparatus. The control unit 5 is operable as the instructing unit, etc., of the image forming apparatus by the CPU 11 configured to control elements of the printer unit 16, etc., in accordance with programs stored in the ROM 12, etc.

The measuring unit 15 measures the internal processing time of the network printer 1. The time in which the CPU 11 controls elements or units of the network printer 1 is obtained by the measuring unit 15, and the measured time is stored in the RAM 13 and the NVRAM 14 as necessary.

The printer unit 16 executes the printing process of image data received from the client terminal apparatus 2. The printer unit 16 executes a page-by-page printing process (hereinafter also simply referred to as a “printing”) of image data containing one or more pages. Although not shown, the printer unit 16 is a so-called laser printer using a semiconductor laser (LD: Laser Diode) as a light source to form an electrostatic latent image on the front side of a photosensitive drum in the present embodiment. The printer unit 16 records image data on a recording medium such as a recording sheet using four colors of toner, which are cyan (C), magenta (M), yellow (Y) and black (K) in the present embodiment. In addition, the printer unit 16 is not limited is not limited to the laser printer, as long as it is a printer requiring a calibration process. For example, the printer unit 16 may be an ink jet printer.

The operation unit 17 includes various types of operation keys provided at the network printer 1. The operation unit 17 allows the user to enter various types of operation inputs. The display unit 18 includes a liquid crystal display panel attached to the network printer 1, which displays various types of setting states and operation states of the network printer 1.

The LAN I/F 19 is an interface for connecting the LAN 3 and the network printer 1 so as to communicate with each other. The printer port I/F 20 is an interface for connecting the client terminal apparatus 2 to the network printer 1. In the present embodiment, the network printer 1 and the client terminal apparatus 2 are connected so as to communicate with each other via the LAN I/F 19. However, the network printer 1 and the client terminal apparatus 2 may be connected to each other via the printer port I/F 20.

Although not described in detail, the printer unit 16 of the network printer 1 includes a charger, a photosensitive drum, an exposure unit, a developing unit, a transfer unit, and a fixing unit (not shown), etc. The image forming characteristics of the printer unit 16 change by the use environment of the network printer 1 and the elapsed period of time, etc. That is, the color valances of images (density of images recorded on the recording sheet) changes by consumption of toners and aging changes of the photosensitive characteristics of the photosensitive drum in the printer unit 16. In order to correct a change in the image forming characteristics, the control unit 5 obtains color correction data by controlling the printer unit 16. The color correction data are obtained by the following processes: transferring a test pattern on the photosensitive drum (not illustrated); and reading the test pattern by a sensor. That is, the color correction data are data showing actually measured densities of images of the test pattern read by the sensor. As used herein, the meaning of the term “color valance” may include at least one of hue, saturation and brightness. The color valance may be adjusted, for example, by changing the color density of each of color components of C, M, Y and K.

The control unit 5 operable as the color correction data generating unit obtains color correction data of four color components of C, M, Y and K by using the printer unit 16. Further, since the method for obtaining the color correction data has been well known, a description of the method is omitted herein. The control unit 5 rewrites the color correction data stored in the NVRAM 14 to the obtained color correction data. Accordingly, the old color correction data stored in the NVRAM 14 is updated to the latest color correction data.

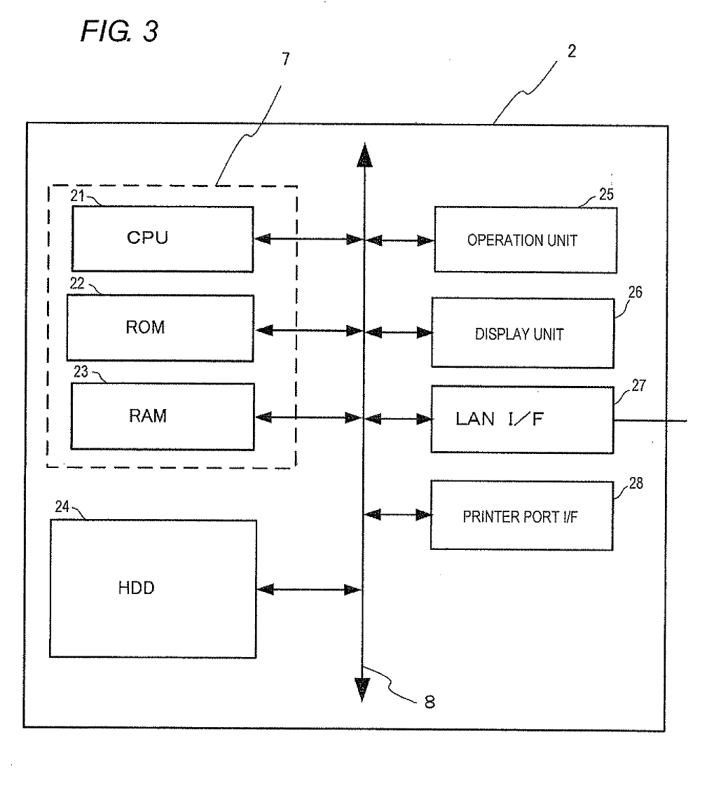

Hereinafter, the client terminal apparatus 2 is described with reference to FIG. 3.

As shown in FIG. 3, the client terminal apparatus 2 is, for example, a personal computer. The client terminal apparatus 2 is connected to the network printer 1 capable of executing reception printing process so as to communicate with each other. The client terminal apparatus 2 transmits image data to the network printer 1.

The control unit 7 controls the entire operations of the client terminal apparatus 2. The control unit 7 is configured as a microcomputer, which includes a CPU 21, a ROM 22, and a RAM 23. The control unit 7 is connected to an HDD 24, an operation unit 25, a display unit 26, a LAN I/F 27, and a printer port I/F 28 via a bus 8 so as to communicate therewith. The configuration of the client terminal apparatus 2 is not limited thereto, and various modifications may be made without departing from the sprit and scope of the present invention.

The CPU 21 controls the operations of elements of the client terminal apparatus 2. The CPU 21 operates based on an operating system (OS), a driver (for example, a printer driver) to control various types of hardware, and programs of various types of application software, etc.

Programs, etc., for controlling the client terminal apparatus 2 and executing calculations are stored in the ROM 22. The RAM 23 is used as the main memory and work area of the CPU 21, in which various types of data used when the CPU 21 executes the above-described programs are temporarily stored.

The control unit 7 including the CPU 21, the ROM 22 and the RAM 23 is operable as an instructing unit, a prohibition transmission unit, a continuation execution unit, and a permission transmission unit of the information processing apparatus.

The HDD 24 is a memory device internally incorporating a memory medium having a large capacity of memory area. The HDD 24 stores programs and data files that are utilized in the client terminal apparatus 2. The control unit 7 generates image data based on the data files stored in the HDD 24. The generated image data are transmitted to the network printer 1 for printing.

A printer driver for transmitting image data to be printed to the network printer 1, which is connected so as to communicate, is stored in the HDD 24. The control unit 7 is operable as the prohibition transmission unit, the continuation execution unit, and the permission transmission unit of the information processing apparatus in accordance with the printer driver stored in the HDD 24, etc.

The operation unit 25 includes a keyboard and various types of pointing devices, etc., and receives operation input such as operation instructions and settings with respect to the client terminal apparatus 2. The display unit 26 includes a CRT and a liquid crystal display, etc., and provides various types of screen information. In detail, the display unit 26 displays a user interface to set operation states of the client terminal apparatus 2 and printing conditions of a printing process, which are instructed to the network printer 1.

The operation unit 25 and the display unit 26 are operable as a selection unit, the first selection unit, the second selection unit, a continuous printing instruction unit and a printing stop instruction unit of the image forming apparatus, for example, by displaying the user interface on the display unit 26 and performing a selection operation using the keyboard of the operation unit 25 in accordance with the printer driver stored in the HDD 24.

The LAN I/F 27 is an interface that connects the LAN 3 and the client terminal apparatus 2 so as to communicate with each other. The printer port I/F 28 is an interface that connects the network printer 1 to the client terminal apparatus 2. In the present embodiment, the client terminal apparatus 2 and the network printer 1 are connected so as to communicate with each other via the LAN I/F 27. However, the client terminal apparatus 2 and the network printer 1 may be connected so as to communicate with each other via the printer port I/F 28.

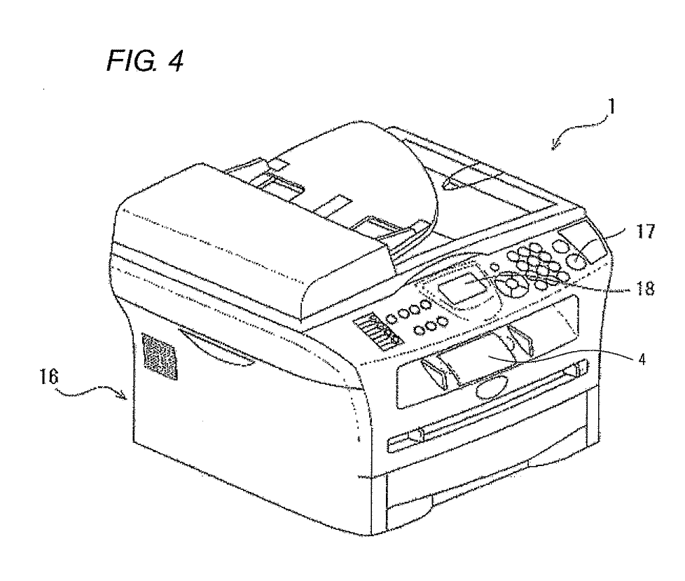

As shown in FIG. 4, the display unit 18 is provided with display means such as a liquid crystal display, etc. The operation unit 17 is provided with inputting means such as various types of buttons and a touch panel, etc. A user may give an instruction to generate color correction data by operating various types of buttons of the operation unit 19. The user sets sheets in a sheet feeding port 4 and gives an instruction to start the printing through the client terminal apparatus 2 or the network printer 1. In response to the instruction, the network printer 1 starts the printing.

(Instructions to generate Color Correction Data)

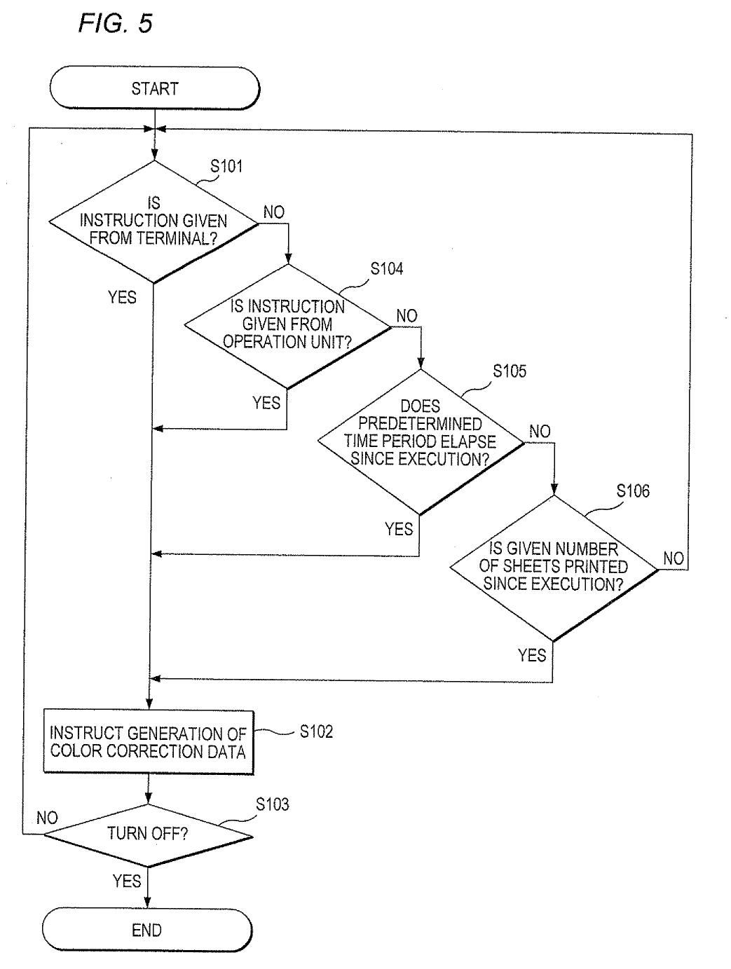

Instructions to generate color correction data to an image forming system according to the embodiments of the invention will be described with reference to FIG. 5. First, it is determined whether an instruction to generate color correction data is given from client terminal apparatuses 2A to 2C (S101: one example of the operation of the instructing unit).

The user gives the instruction to generate color correction data using the operation unit 25 such as a keyboard from any one of the respective client terminal apparatuses 2A to 2C. If an instruction to generate color correction data is given from any client terminal apparatuses 2A to 2C (S101: YES), the control unit 5 operable as the color correction data generating unit of the network printer 1 receives the instruction via the LAN I/F 27 by the control unit 7 operable as the instructing unit of the client terminal apparatus 2. Consequently, the instruction to generate color correction data is given (S102).

The instruction to generate the color correction data described above is executed, for example, in case in which, when a user A is printing image data by the network printer 1 using the client terminal apparatus 2A, a user B gives an instruction to generate color correction data using the client terminal apparatus 2B.

Next, in S103, it is determined whether the operation of the network printer 1 is turned off. If the operation of the network printer 1 is not turned off (S103: NO), the process returns to S101 again. If the operation of the network printer 1 is turned off (S103: YES), the process is terminated.

Next, if an instruction of color correction data is given from the operation unit 17 of the network printer 1 (S104: YES, one example of the operation of the instructing unit), the instruction to generate color correction data is given (S102). In S102, the instruction to generate color correction data is given from the operation unit 17 to the control unit 5 operable as the color correction data generating unit of the network printer 1.

Next, if S104 is NO, the process advances to S105, and if a predetermined period (which may be fixed period) of time elapses since the latest color correction data are created (S105: YES, one example of the instructing unit), the instruction to generate color correction data is given (S102). In this case, the control unit 5 operable as the instructing unit gives an instruction to generate color correction data, for example, 24 hours since the latest color correction data are created.

Next, if S105 is NO, the process advances to S106, and if a printing process of a predetermined number of sheets is completed after the latest color correction data are created (S106: YES, one example of the operation of the instructing unit), the instruction to generate color correction data is given (S102). In this case, the control unit 5 operable as the instructing unit gives an instruction to generate color correction data after the printing of image data, for example, of 100 sheets is finished since the latest color correction data are created. If S106 is NO, the process returns to S101 again.

In the above-described flow-chart, the condition that the given time period elapses since the latest color correction data are created (i.e., since the last update of the color correction data) (S105) and the condition that the printing process of the given number of sheets is completed since the latest color correction data are created (S106) are used for the conditions for giving the color correction data generation instruction. However, any other conditions may be used for the condition for giving the color correction data generation instruction. For example, the temperature inside the network printer 1 may be used for the condition. Specifically, when the temperature in the network printer 1 changes by predetermined temperature since the last update of the color correction data, the instruction to generate color correction data may be given.

(Control Process of Network Printer 1)

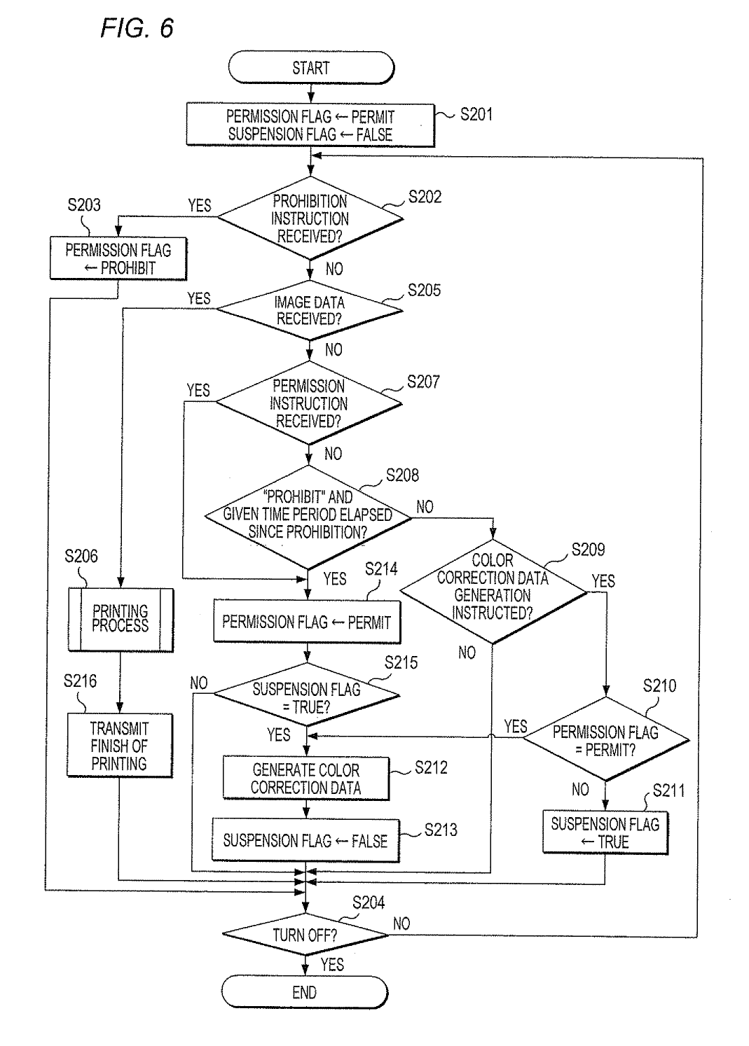

Next, a control process in connection with a color correction data generation process and a printing process of the network printer 1 as one example of the image forming apparatus will be described with reference to FIG. 6.

First, in the initial starting such as after turning on the power or re-starting of the network printer 1, a setting for a control flag to control the color correction data generation process is performed (S201). Specifically, the control flag includes a color correction data generation permission flag (hereinafter referred to as a permission flag) and a color correction data generation suspension flag (hereinafter referred to a suspension flag). In the setting of S201, the permission flag is set to “Permit” and the suspension flag is set to “False”. Information on the control flags is stored in the RAM 13.

Next, in S202, it is determined whether the control unit 5 operable as the receiving unit of the network printer 1 receives a prohibition instruction for prohibiting generation of color correction data. The prohibition instruction is transmitted from the client terminal apparatus 2 by the processing of the terminal apparatus 2 (the processing will be described later).

If the receiving unit of the network printer 1 receives the prohibition instruction for prohibiting generation of the color correction data (S202: YES), the permission flag is set to “Prohibit” (S203). The time at the point when the permission flag is set to “Prohibit” is measured by the measuring unit 15, and the time is stored in the NVRAM 14.

Unless the operation of the network printer 1 is ended (S204: NO) by turning off the power of the network printer 1 after the permission flag is set to “Prohibit” in S203, the process continuously returns to S202.

Next, if the control unit 5 operable as the receiving unit of the network printer 1 does not receive the prohibition instruction for prohibiting generation of the color correction data (S202: NO), it is determined whether the image data are received (S205).

Where the image data are received (S205: YES), a printing process (S206) is executed. After the printing process of the image data is finished, information indicating that the printing process has been completed is transmitted to the network printer 1 (S216).

Next, if the control unit 5 operable as the receiving unit of the network printer 1 does not receive a prohibition instruction for prohibiting generation of the color correction data and the image data to be printed from the client terminal apparatus 2 which are transmitted by the processing at the client terminal apparatus 2 described later (S202: NO, S205: NO), the process advances to S207.

In S207, it is determined whether the control unit 5 operable as the receiving unit of the network printer 1 receives the instruction for permitting generation of color correction data transmitted from the client terminal apparatus 2.

If the receiving unit of the network printer 1 does not receive the permission instruction for permitting generation of the color correction data (S207: NO), it is determined whether the permission flag is “Prohibit,” and 30 minutes defined as an example of a fixed period of time elapse since the control unit 5 operable as the receiving unit of the network printer 1 receives the prohibition instruction for prohibiting generation of the color correction data (S208).

The period of time elapsed after the control unit 5 operable as the receiving unit of the network printer 1 receives the prohibition instruction for prohibiting generation of color correction data is obtained from the measuring unit 15 based on the time when the permission flag stored in the NVRAM 14 is set to “Prohibit” and the current time. If the permission flag is “Prohibit” and the period of time exceeds 30 minutes (S208: YES), the permission flag is set to “Permit” (S214: One example of the operation of the permission unit).

Next, where the period of time does not exceed 30 minutes (S208: NO), it is determined whether the control unit 5 operable as the instructing unit of the network printer 1 or the control unit 7 operable as the instructing unit of the client terminal apparatus 2 gives an execution instruction to generate color correction data (S209).

If the execution instruction to generate color correction data is given by the instructing unit (S209: YES), the control unit 5 operable as the prohibition control unit determines which of “Prohibit” or “Permit” is set as the permission flag stored in the RAM 13 (S210). If the permission flag is set “Prohibit” (S210: NO), the suspension flag is set to “True” and is then stored in the RAM 13 (S211: One example of the operation of the suspending unit), and the process advances to S204 without generating any color correction data. In S204, if the operation of the network printer 1 is not ended (S204: NO), the process returns to S202.

If the permission flag is set “Permit” (S210: YES), the control unit 5 operable as the color correction data generating unit of the network printer 1 generates color correction data (S212), and the process advances to S213. The control unit 5 operable as the suspending unit sets the suspension flag to “False” (S213). In S204, unless the operation of the network printer 1 is ended (S204: NO), the process returns to S202.

Next, the description returns to S214 in which the permission flag has been set to “Permit.” It is determined whether the suspension flag is “True” or “False” in a state in which the permission flag is set to “Permit” (S215). If the suspension flag is “False” (S215: NO), the process advances to S204. If the suspension flag is “True” (S215: YES), color correction data are generated (S212).

The suspension flag “True” indicates a case in which although the execution instruction to generate color correction data has been given (S209: YES), no color correction data have been generated because the permission flag is set “Prohibit” (S210: NO). Accordingly, in a case in which the execution instruction of the color correction data has been already given at the time point when generation of the color correction data is permitted, the color correction data is generated.

After the control unit 5 operable as the color correction data generating unit executes a process to generate color correction data (S212), the control unit 5 operable as the suspending unit sets the suspension flag from “True” to “False” (S213). The process advances to S204, and unless the operation of the network printer 1 is ended (S204: NO), the process returns to S202.

The network printer 1 repeats the determinations of S202, S205, S207, S208, and S209 during a period from the initial start such as after turning on the power or re-starting of the network printer 1 to the end of the operation of the network printer 1 such as shut-off of the power, and the network printer 1 performs the process based on the flowchart of FIG. 6 as described above whenever the repeating.

(Printing Process of Network Printer 1)

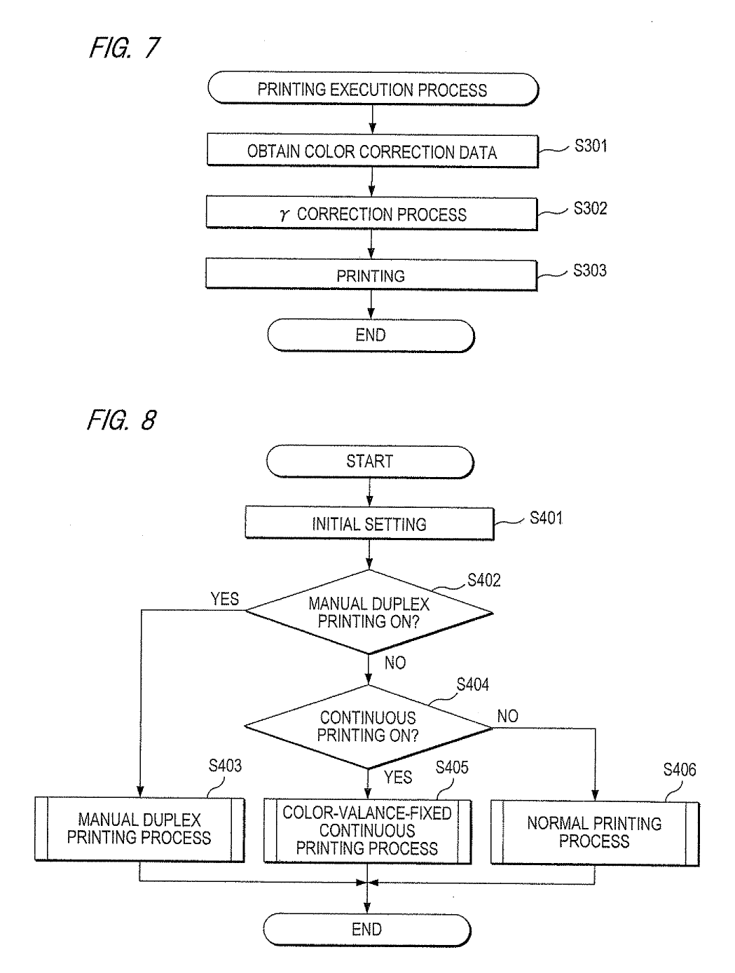

Next, a printing process of image data of the network printer 1 will be described with reference to FIG. 7 showing a flowchart of a printing execution process in the network printer 1. The printing process corresponds to the process of S206 of FIG. 6. First, the color correction data stored in the NVRAM 14 which is a non-volatile memory is obtained (S301).

A γ correction process is carried out (S302). The γ correction process is a process for reflecting the color correction data (such as the color correction data created as described above) in the image data used for printing as the correction values.

A dithering process is performed after the γ correction process. Thereafter, a printing process is performed on a sheet by the printer unit 16 using the corrected image data (S303). When the printing is performed, the density is corrected, for example, by adjusting a pulse width of a laser beam of the printer unit 16 (not illustrated), and adjusting the voltage applied to the development rollers, the photosensitive drum, etc., based on the correction value reflected by the γ correction process.

The printing process of FIG. 7 is not limited to the embodiment of the present invention, and it is not necessary to carry out the γ correction process by the network printer 1. That is, the color correction data are transmitted from the network printer 1 to the client terminal apparatus 2. Thereafter, the y correction process of the image data is performed by the client terminal apparatus 2, the image data subjected to the y correction process are transmitted to the network printer 1, and the printing process is executed.

(Initial Setting of Printing Process of Client Terminal Apparatus)

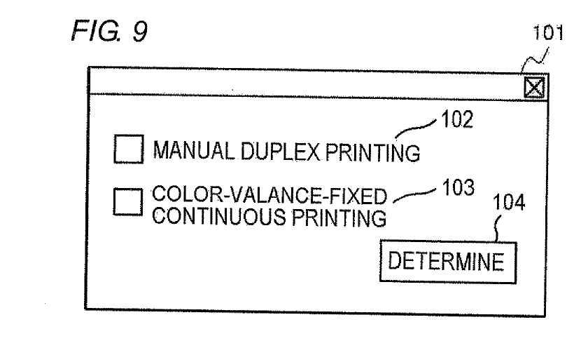

Next, a process of the client terminal apparatus 2 as one example of the information processing apparatus will be described with reference to FIG. 8. First, the selection unit displays, on the display unit 26, a printing setting screen 101 as shown in FIG. 9 for selecting whether a series of continuous pieces of image information is continuously printed (S401).

The printing setting screen 101 includes a selection button 102 (one example of the first selection unit) for selecting manual duplex printing and a selection button 103 (one example of the second selection unit) for selecting color-valance-fixed continuous printing. The user can select selection buttons of the printing setting screen 101 displayed on the display unit 18 by using the operation unit 25 such as a keyboard or a mouse. Then, the user presses a determination button 104. Therefore, the result (manual duplex printing or color-valance-fixed continuous printing) selected by using the display unit 26 and the operation unit 25 is set as the initial setting and is stored in the RAM 23.

If the determination button 104 is pressed in a state where the user does not select either the selection button 102 for selecting the manual duplex printing or the selection button 103 for selecting the color-valance-fixed continuous printing, a normal printing process is set in the control unit 7 as the initial setting.

Next, in S402, if the initial setting is manual duplex printing (S402: YES), the manual duplex printing (S403) is executed. If the manual duplex printing is not set in the initial setting (S402: NO), it is determined in S404 whether the color-valance-fixed continuous printing is selected in the initial setting. If the color-valance-fixed continuous printing is selected in the initial setting (S404: YES), the color-valance-fixed continuous printing is executed (S405).

In S404, if the color-valance-fixed continuous printing is not selected in the initial setting, the normal printing process is executed (S406). If executed one of the printing processes (S403, S405, and S406) is finished based on the initial setting, the printing process at the client terminal apparatus 2 is ended.

### 1. Embodiment 1

(Manual Duplex Printing Process of Client Terminal Apparatus]

(Processing at Client Terminal Apparatus 2)

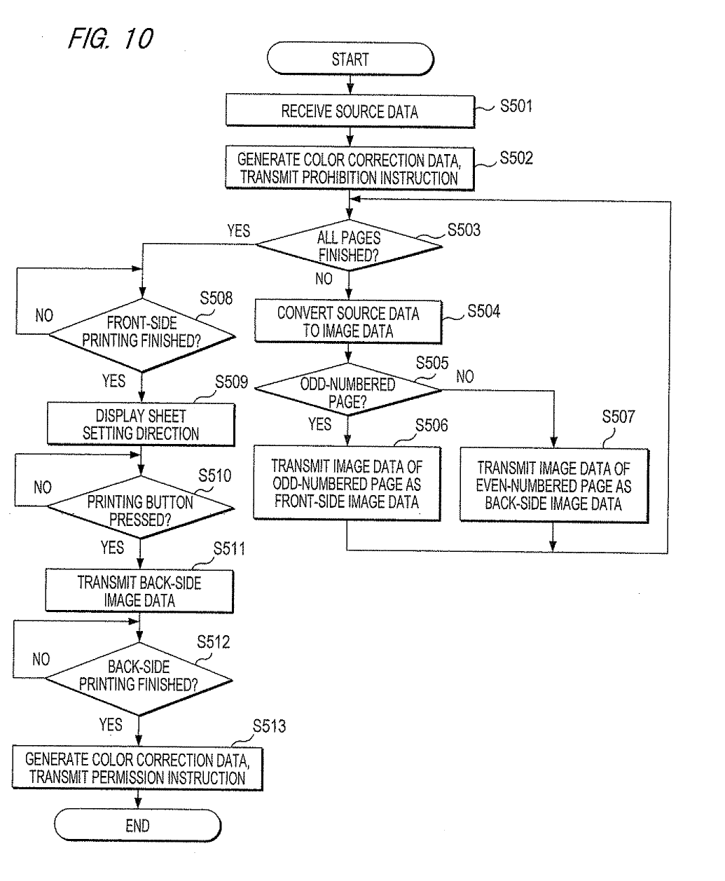

Next, the manual duplex printing process (FIG. 8: S403) at the client terminal apparatus 2 will be described with reference to FIG. 10 along with the control of the network printer 1 of FIG. 6 which has already been described.

First, source data containing one or more pages are created by a program for creating images and/or documents. The program is stored in the HDD 24 of the client terminal apparatus 2. The source data are stored in the HDD 24 as a data file. The control unit 7, which is controlled based on the printer driver stored in the HDD 24 of the client terminal apparatus 2, receives the source data (S501).

Next, the control unit 7 operable as the prohibition transmission portion transmits the prohibition instruction to the network printer 1 which can be accessed via the LAN I/F 27 and the LAN 3 (S502). The prohibition instruction is used for prohibit generation of color correction data.

(Processing at Network Printer 1 with Processing at Client Terminal Apparatus 2)

If the control unit 5 operable as the receiving unit of the network printer 1 receives a prohibition instruction for prohibiting generation of the color correction data at the network printer (S202: YES), the process advances to S203, and the permission flag is set to “Prohibit.” In addition, if the permission flag is not “Permit” at the permission unit (S214), or if the permission flag is not “Permit” at the prohibition control unit (S210), generation of the color correction data (S212) is not performed. That is, as long as the permission flag is not “Permit,” generation of the color correction data is prohibited at the network printer 1.

(Processing at Client Terminal Apparatus 2)

The description returns to the processing at the client terminal apparatus 2 again. The source data contains a plurality of pages. In S503, it is determined whether the processing of all the pages has finished. If all the pages have finished (S503: YES), the process advances to S508. If the processing of all the pages is not finished (S503: NO), the process advances to S504, and the source data are converted, page by page, to image data having a data format described by the page description language (PDL data) (S504).

Next, in S505, it is determined whether the image data created by converting the source data page by page is an odd-numbered page (S505). If the converted page is the odd-numbered page (S505: YES), the image data of odd-numbered page are transmitted to the network printer 1 as front-side image data. If the converted page is not odd-numbered page (S505: NO), image data of even-numbered page is temporarily stored in the RAM 23 as back-side image data (S507).

(Processing at Network Printer 1 with Processing at Client Terminal Apparatus 2).

If the control unit 5 operable as the receiving unit of the network printer 1 receives the front-side image data in the network printer 1 (S205: YES), the process advance to S206, and the printing process of the front-side image data is executed. If the printing process of the front-side image data is finished, the control unit 5 transmits information indicating that the printing process has finished to the control unit 7 of the client terminal apparatus 2 (S216).

(Processing at Client Terminal Apparatus 2)

The description returns to the processing at the client terminal apparatus 2 again. If the processing of all the pages has finished (S503: YES), the process advances to S508, and it is determined whether the printing process of the front-side printing data with respect to all the odd-numbered pages has finished at the network printer 1. If the printing process of all the odd-numbered pages of the front-side printing data has not finished, the process advances to NO in S508.

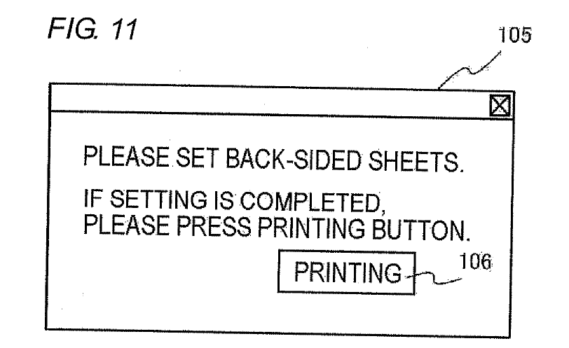

If the printing process of the front-side printing data with respect to all the odd-numbered pages has finished (S508: YES), a user interface 105 (FIG. 11) is displayed on the display unit 26 (S509). The user interface 105 is an indication for requesting the user to place discharged sheets (i.e., sheets on which images for odd number pages has been recorded) at the sheet feeding port 4 so as to face the direction appropriate for the back-side printing (e.g., facing up a second side of the sheet which is opposite to a first side faced up at the time of placing the sheet for the front-side printing).

(Processing by Network Printer 1 with Processing at Client Terminal Apparatus 2)

A case is taken into consideration in which an instruction to generate color correction data is given by the instructing unit of the network printer 1 or by the client terminal apparatus 2B different from the client terminal apparatus 2A that performs the printing processing. At this time, the process advances to S209 via S202, S205, S207 and S208. In S209, since the permission flag is not “Permit” (S210: NO) although an execution instruction to generate the color correction data is given (S209: YES), the control unit 5 operable as the prohibition control unit prohibits generation of color correction data at the network printer 1. That is, in the present embodiment, even if generation of the color correction data is instructed at the moment when the printing of the front-side image data is finished, generation of the color correction data is prohibited.

(Processing at Client Terminal Apparatus 2)

The description returns to processing at the client terminal apparatus 2 again. A user sets the discharged sheets to the sheet feeding port 4 facing the direction as instructed. Thereafter, using the operation unit 25 such as a keyboard or a mouse, etc., the user presses a printing button 106 of the user interface 105 displayed on the display unit 26. When the printing button 106 is pressed (S510: YES), the control unit 7 transmits the back-side image data stored in the RAM 23 to the network printer 1 (S511).

(Processing at Network Printer 1 in Line with Processing at Client Terminal Apparatus 2)

The control unit 5 operable as the receiving unit of the network printer 1 receives the back-side image data in the network printer 1 (S205: YES). In S206, the printing process of the back-side image data is executed. If the printing process of the back-side image data is finished, the control unit 5 transmits information indicating that the printing process has finished to the control unit 7 of the client terminal apparatus 2 (S216).

(Processing at Client Terminal Apparatus 2)

The description returns to the processing at the client terminal apparatus 2 again. In S512, it is determined whether the printing process of all the pages of the back-side image data in the network printer 1 has finished. If the printing process of all the pages of the back-side image data has not finished (S512: No), the process returns to the determination in S512.

If the printing process of the back-side image data has finished with respect to all the even-numbered pages (S512: YES), the process advances to S513. In S513, the control unit 7 operable as the permission transmission unit transmits an instruction for permitting generation of color correction data to the network printer 1 which can be accessed via the LAN 3.

(Processing at Network Printer 1 with Processing at Client Terminal Apparatus 2)

If the control unit 5 operable as the receiving unit of the network printer 1 receives the permission instruction for permitting generation of the color correction data (S207: YES), the control unit 5 operable as the permission unit sets the permission flag to “Permit” (S214).

Next, the process advances to S215. In Embodiment 1, since the suspension flag is “True” (S215: YES), the color correction data are generated (S212). After the color correction data are generated, the suspension flag is set to “False” by the suspending unit (S213).

### Advantages of Embodiment 1

In Embodiment 1, even if the network printer 1 receives the instruction to generate color correction data after the start of printing process of the front-side image data but before the start of the printing of the back-side image data, no color correction data are generated. That is, it is possible to select the manual duplex printing which prints the front-side image data printed first and the back-side image data printed next as a series of continuous image data. When the manual duplex printing is selected, generation of the color correction data is prohibited until printing of the front-side image data and the back-side-image data is completed. Therefore, it is possible to prevent the color valances of the front-side image and the back-side image from changing.

In the case in which the instruction to generate color correction data is given during the printing of the front-side image data and the back-side image data printed next as a series of continuous image data, the color correction data are generated soon if the suspension flag is set to “Suspend” at the time point when the permission flag is changed from “Prohibit” to “Permit.” Therefore, it is possible to efficiently generate the color correction data.

Further, in the present embodiment, generation of color correction data is prohibited until a user presses the printing start button (S510: YES) since the printing of the front-side image data is finished. If the network printer 1 continues in a state in which a user does not press the printing start button, the color correction data are not generated, which may be rather inconvenient. Therefore, in order to avoid this inconvenience, in S208 of FIG. 6, it is determined whether a time period, e.g., 30 minutes elapses since the control unit 5 operable as the receiving unit of the network printer 1 receives the prohibition instruction for prohibiting generation of color correction data. The time period of 30 minutes is a reference to determine that a user forgets to give an instruction to print the next image data. Therefore, it is possible to prevent prohibition of generation of color correction data due to a user forgetting to give an instruction to print the next image data.

### 2. Embodiment 2

(Color-Valance-Fixed Continuous Printing Process of Client terminal Apparatus)

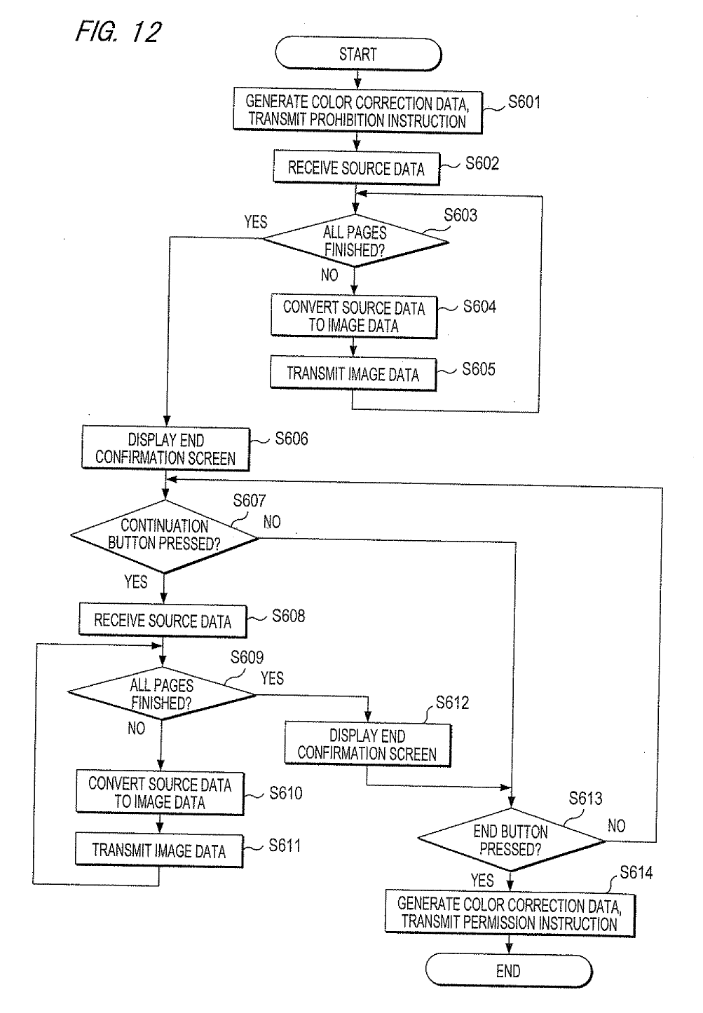

With reference to a flowchart of FIG. 12, a color-valance-fixed continuous printing process (FIG. 8: S405) at the client terminal apparatus 2 will be described along with the network printer 1 of FIG. 6 which has already been described.

(Processing at Client Terminal Apparatus 2)

First, the control unit 7 operable as the prohibition transmission unit transmits a prohibition instruction for prohibiting generation of color correction data to the network printer 1 which can be accessed via the LAN 3 (S601).

Source data containing one or more pages are created by a program for creating images and documents. The program is stored in the HDD 24 of the client terminal apparatus 2. The source data are stored in the HDD 24 as a data file. In this embodiment, a plurality of pieces of source data are created by one or more programs. The control unit 7 receives (reads) one of the plurality of pieces of source data from the HDD 24 (S602).

(Processing in Network Printer 1 in Line with Processing at Client terminal Apparatus 2)

The network printer 1 sets permission flag “Prohibit” on receiving a prohibition instruction for prohibiting generation of color correction data, as in the processing of manual duplex printing. As long as the permission flag is not “Permit,” generation of the color correction data is prohibited at the network printer 1.

The source data contains a plurality of pages. As in the manual duplex printing process (FIG. 10: S503), it is determined whether processing is finished with respect to all the pages (S603). If the processing for all the pages has not been finished (S603: NO), the process advances to S604, and the source data are converted to image data page by page (S604). The image data converted page by page are transmitted to the network printer 1 (S605).

(Processing in Network Printer 1 in Line with Processing at Client Terminal Apparatus 2)

The control unit 5 operable as the receiving unit of the network printer 1 receives the image data at the network printer 1 (S205: YES). In S206, the printing process of the image data is executed page by page. Thereafter, the control unit 5 transmits information indicating that the printing process has finished to the control unit 7 of the client terminal apparatus 2 (S216).

(Processing at Client Terminal Apparatus 2)

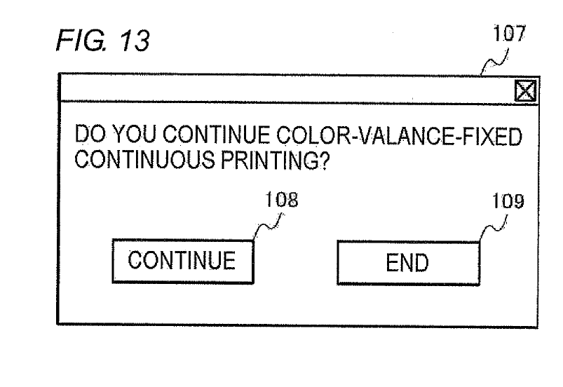

The description returns to processing at the client terminal apparatus 2 again. If a series of processes (S604 and S605) with respect to all the pages is finished (S603: YES), the process advances to S606. In S606, an end confirmation screen 107 (FIG. 13) is displayed on the display unit 26 after the printing of the transmitted image data (one example of one piece of image information) is finished (S606). A user may select a continuation button 108 (one example of the continuous printing instruction unit) or an end button 109 (one example of the printing stop instruction unit) of the end confirmation screen 107 displayed on the display unit 26 by using the operation unit 25 such as a keyboard, etc.

A selection screen is displayed after the continuation button 108 is pressed. The selection screen allows a user to select one piece of source data from a plurality of pieces of source data. The plurality of pieces of types of source data are created in advance by one or more programs for creating images and documents. The user can select arbitral one piece of source data from the plurality of pieces of source data which are stored in the HDD 24 as data files (the selection screen is not illustrated). As used herein, the “color-valance-fixed continuous printing” means that there are a plurality of pieces of source data (one example of image information) and next source data are also continuously printed with the same color valances after the printing of one type of source data is finished. Also, the color-valance-fixed continuous printing is not limited to a case where there are a plurality of source data, and includes a case where the same source data are continuously printed. This corresponds to a case where it is desired that the same source data are printed in increments of 100 copies, etc.

(Processing at Network Printer 1 with Processing at Client Terminal Apparatus 2)

A case is taken into consideration in which an instruction to generate color correction data is given in the network printer as in the manual duplex printing. At this time, since the permission flag is not “Permit,” the control unit 5 operable as a prohibition control unit prohibits generation of the color correction data in the network printer 1 (S210: NO).

(Processing at Client Terminal Apparatus 2)

The description returns to processing at the client terminal apparatus 2 again. In S607, it is determined whether the continuation button 108 (an example of the continuous printing instruction unit) is pressed. If the continuation button 108 is pressed (S607: YES), processing from S608 to S612 is performed. The processes S608, S609, S610, S611 and S612 are identical to the processes S602, S603, S604, S605 and S606, respectively. In S611, the image data (one example of the next piece of image information) is transmitted to the network printer 1 (one example of the continuous execution unit: S608 to S612).

(Processing in Network Printer 1 in Line with Processing at Client Terminal Apparatus 2)

The network printer 1 receives the image data page by page (S205: YES). In S206, the printing process of the image data is executed page by page. If the printing process is finished, the control unit 5 transmits the information indicating that the printing process has been finished to the control unit 7 of the client terminal apparatus 2.

(Processing at Client Terminal Apparatus 2)

The description returns to processing at the client terminal apparatus 2 again. In S612, the end confirmation screen 107 (FIG. 13) is displayed on the display unit 26 again (S612). If a user does not press the end button 109 (an example of the printing stop unit) by using the operation unit 25 (S613: NO), the process returns to S607, and it is determined whether the continuation button 108 (an example of the continuous printing instruction unit) is pressed. These processes are repeated until the end button 109 (an example of the printing stop unit) is pressed.

If a user desires to continuously perform continuous printing of the next piece of source data, the user selects the continuation button 108 on the end confirmation screen 107. In this case, the processes from S608 through S612 are repeated. If the source data are continuously selected by the continuous printing instruction unit, the color correction data is not generated for the time being.

If it is not necessary for the user to print the next piece of source data, the user selects the end button 109 on the end confirmation screen 107 (S613: YES). In S614, the control unit 7 operable as the permission transmission unit transmits a permission instruction for permitting generation of color correction data to the network printer 1 which can be accessed via the LAN 3 (S614).

(Processing at Network Printer 1 with Processing at Client Terminal Apparatus 2)

If the control unit 5 operable as the receiving unit of the network printer 1 receives a permission instruction for permitting generation of the color correction data in the network printer 1 as in the manual duplex printing (S207: YES), the control unit 5 operable as the permission unit sets the permission flag to “Permit” (S214).

### Advantages of Embodiment 2

In Embodiment 2, it is possible to select, by the second selection unit, color-valance-fixed continuous printing in which the plurality of pieces of source data are continuously printed with the same color valances. If the color-valance-fixed continuous printing is selected, it is possible to continuously print the next image information by the continuous printing instruction unit. In the meantime, the color correction data are not generated, and it is possible to prevent the color valances of images from changing when the plurality of pieces of source data are printed.

If a user selects the continuation button 108 (an example of the continuous printing instruction unit), the client terminal apparatus 2 gives an instruction to continuously print the next piece of source data. Based on this instruction, the client terminal apparatus 2 continuously transmits the image data, to which the source data are converted, to the image forming apparatus by means of the continuation execution unit. Accordingly, while the network printer 1 is printing the image data, the color valances of the images of the image data to be printed can be prevented from changing.

That is, until the printing stop instruction unit gives the instruction not to perform printing, a user can print the source data without changing the color valances of the images as a series of continuous pieces of source data when printing a plurality of pieces of source data.

Further, even in Embodiment 2, color correction data are soon generated if the suspension flag is “Suspend” at the moment when the permission flag is set to “Permit” in case in which an instruction to generate color correction data is given. Therefore, it is possible to efficiently generate the color correction data. In addition, incorrect prohibition of generation of color correction data, which is due to a user forgetting to press the end button 109, can be prevented by determining whether 30 minutes, which are defined as a exemplified fixed period of time, have elapsed (FIG. 6: S208).

### 3. Other Embodiments

The embodiments of the present invention are not limited to Embodiments 1 and 2, and various modifications may be made without departing from the sprit and scope of the invention. For example, Embodiments 1 and 2 may be combined.

What is claimed is:

1. An image forming system comprising:
an information processing apparatus comprising a first communication unit; and
an image forming apparatus comprising: a second communication unit configured to receive image information transmitted from the first communication unit; and an image forming unit configured to form an image on a recording sheet based on the image information;
wherein at least one of the information processing apparatus and the image forming apparatus comprises an instructing unit configured to give a correction instruction to instruct a generation of color correction data used for a correction of the image information,
wherein the information processing apparatus comprises:
a selection unit configured to select whether to print a plurality of pieces of image information as a series of continuous pieces of image information without performing the correction of the color correction data during a printing of the series of continuous pieces of image information; and
a prohibition transmission unit configured to transmit the image information and a prohibition instruction for prohibiting generation of color correction data if the selection unit selects that the image information is to be printed as the series of continuous pieces of image information, and
wherein the image forming apparatus comprises:
a color correction data generating unit configured to generate color correction data based on the correction instruction from the instructing unit;
a receiving unit configured to receive the image information and the prohibition instruction which are transmitted from the prohibition transmission unit through the first communication unit and the second communication unit; and
a prohibition control unit configured to prohibit the generation of color correction data until the image forming unit finishes the printing of the series of continuous pieces of image information when the receiving unit receives the series of continuous pieces of image infatuation and the prohibition instruction, even if the instructing unit gives the instruction to generate the color correction data.

2. The image forming system according to claim 1,
wherein the selection unit comprises a first selection unit configured to select a manual duplex printing mode so as to print first image information of one of odd-numbered page and even-numbered page on a first side of the recording medium and then to print second image information of the other of odd-numbered page and even-numbered page on a second side of the recording medium opposite to the first side after the recording medium on which the first image information has been printed is set at a sheet feeding portion of the image forming apparatus, and
wherein when the manual duplex printing mode is selected, the first image information and the second image information are printed as the series of continuous pieces of image information without performing the generation of the color correction data.

3. The image forming system according to claim 1,
wherein the selection unit comprises a second selection unit configured to select a color-valance-fixed continuous printing mode in which the image forming unit prints one piece of image information and thereafter prints a next piece of image information with a same color valance,
wherein the information processing apparatus further comprises:
a continuous printing instruction unit configured, when the color-valance-fixed continuous printing mode is selected, to give a continuous printing instruction to continuously print the next piece of image information after the printing of the one piece of image information is finished; and
a continuous execution unit configured to transmit the next piece of image information to the image forming apparatus in accordance with the continuous pieces of printing instruction, and
wherein the next piece of image information transmitted by the continuous execution unit and the one piece of image information are printed as the series of continuous image information without generating the correction of the color correction data.

4. The image forming system according to claim 3,
wherein the information processing apparatus further comprises a printing stop instruction unit configured to give a stop instruction not to print the next piece of image information as the series of continuous image information after the color-valance-fixed continuous printing mode is selected; and
wherein the continuous printing instruction unit gives the continuous printing instruction until the stop instruction is given by the printing stop instruction unit.

5. The image forming system according to claim 1,
wherein the information processing apparatus further comprises a permission transmission unit configured to transmit a permission instruction for permitting the generation of color correction data after the series of continuous pieces of image information is transmitted,
wherein the image forming apparatus comprises a permission unit configured to permit the generation of color correction data when the receiving unit receives the permission instruction transmitted from the permission transmission unit and after the printing of the series of continuous image information is finished, and
wherein the color correction data generating unit generates the color correction data based on the correction instruction when the generation of the color correction data is permitted by the permission unit.

6. The image forming system according to claim 5,
wherein the image forming apparatus further comprises a measuring unit configured to measure a time period elapsed after the receiving unit receives the prohibition instruction, and
wherein the permission unit permits the generation of color correction data when the time measured by the measuring unit reaches a predetermined time period.

7. The image forming system according to claim 5,
wherein the image forming apparatus further comprises a suspending unit configured to suspend the generation of color correction data when the generation of color correction data is instructed by the instructing unit and the receiving unit has received the prohibition instruction, and
wherein the color correction data generating unit generates the color correction data if the suspending unit suspends the generation of color correction data when the permission unit permits the generation of color correction data

8. An image forming apparatus comprising:
an image forming unit configured to perform a printing operation so as to print an image on a recording medium;
a communication unit configured to receive image data and an instruction for controlling the image forming apparatus;
a memory configured to store color correction data;
a color correction data generating unit configured to generate a new color correction data and update the color correction data stored in the nonvolatile memory with the new color correction data; and
a control unit connected to the image forming unit, the communication unit, the color correction data generating unit and the nonvolatile memory,
wherein when the control unit receives the image data and the instruction via the communication unit, the control unit is operable to:
perform a first correction when the instruction contains a first instruction which instructs performing the printing operation without updating the color correction data, wherein, in the first correction, the control unit corrects a gradation of an image contained in the image data using existing color correction data stored in the nonvolatile memory;
perform a second correction when the instruction does not contain the first instruction and also when a given condition is satisfied, wherein, in the second correction, the control unit causes the color correction data generating unit to generate the new color correction data and update the color correction data stored in the nonvolatile memory with the new color correction data, and corrects the gradation of the image contained in the image data using the new color correction data;
perform a third correction when the instruction does not contain the first instruction and also when the given condition is not satisfied, wherein, in the third correction, the control unit corrects the gradation of the image contained in the image data using the existing color correction data stored in the nonvolatile memory; and
control the image forming unit so as to form an image on the recording medium based on corrected image data that have been corrected by one of the first correction, the second correction and the third correction.

9. The image forming apparatus according to claim 8, wherein the given condition is a predetermined condition on which the color correction data is to be updated.

10. The image forming apparatus according to claim 9,
wherein the predetermined condition comprises at least one of first to third conditions,
wherein the first condition is that a number of printed recording media since a last update of the color correction data is a predetermined number or more,
wherein the second condition is that a time elapsed from the last update of the color correction data is a predetermined time period or more, and
wherein the third condition is that a temperature in the image forming apparatus changes by a predetermined temperature from the last update of the color correction data.
